(19) United States
(12) Patent Application Publication
(10) Pub. No.: US 2009/0229923 A1
(43) Pub. Date: Sep. 17, 2009

(54) Traction sheave elevator without counterweight

(76) Inventors: Esko Aulanko, Kerava (FI); Antti Ikonen, Hyvinkaa (FI); Pekka Leppaaho, Hyvinkaa (FI); Matti Rasanen, Hyvinkaa (FI); Teemu Tolonen, Turku (FI); Petri Pukkila, Hyvinkaa (FI)

Correspondence Address: HARNESS, DICKEY & PIERCE, P.L.C., P.O. BOX 8910, RESTON, VA, 20195, US

(21) Appl. No.: 12/385,787

(22) Filed: Apr. 20, 2009

Related U.S. Application Data
(63) Continuation of application No. PCT/FI2007/000272, filed on Nov. 8, 2007.

(30) Foreign Application Priority Data
Nov. 10, 2006 (FI) 20060989
Nov. 29, 2006 (FI) 20061050

(51) Int. Cl. B66B 7/06

(52) U.S. Cl. 187/266

(57) ABSTRACT

The subject of the invention is a traction sheave elevator without counterweight, which comprises at least a drive machine with traction sheave, hoisting ropes, an elevator car guided on its track or the like, car guide rails on one side of the elevator car, which is supported on the hoisting ropes such that the hoisting ropes are on one side of the elevator car. The elevator contains a plurality of rope pulley modules, which comprise a plurality of diverting pulleys.

This application is a continuation of PCT/FI2007/000272 filed on Nov. 8, 2007, which is an international application claiming priority from FI 20060989 filed on Nov. 10, 2006 and FI 20061050 filed on Nov. 29, 2006, the entire contents of which are hereby incorporated by reference.

The present invention relates to a traction sheave elevator without counterweight as defined in the preamble of claim 1.

More particularly this invention relates to the use of the space of an elevator shaft and especially to the minimization of the use of the space by reducing the space taken by the hoisting machine and other parts. It is prior art that the hoisting system of an elevator can be disposed on one side of the elevator car. One such prior-art solution is presented in PCT publication WO 2006/043317. Numerous other hoisting arrangements are also known, in which the car is hoisted from both sides. Those solutions as described above contain numerous drawbacks, such as e.g. that the solutions take space, are difficult to install, expensive and also slow to install.

The purpose of this invention is both to achieve an inexpensive and reliable arrangement in an elevator, which saves as much shaft space as possible and especially saves the bottom space of the elevator shaft, in which case a shaft utilization rate that is as great as possible is achieved, which especially in old buildings is very important. The purpose is to achieve a small and compact construction, which is as well suited as possible, in the vertical direction and in the cross-section direction, to the space that the elevator on its track needs and the guide rail line with its positioning determines. In this case the goal is, among other things, to enable with the selection and with the positioning of components that the elevator car can, at the bottom, drive as far downwards as possible alongside the diverting pulley of the overspeed governor and correspondingly, at the top, as far upwards as possible alongside the overspeed governor. One purpose of the invention is thus to achieve e.g. a type of reliable elevator arrangement, in which the hoisting machine can essentially be formed from a small number of parts that are installed once such that the interpositioning of the components is simultaneously compact, precise, safe and easy to position.

The arrangement of the invention is characterized by what is disclosed in the characterization part of claim 1. Other embodiments of the invention are characterized by what is disclosed in the other claims. Some inventive embodiments are also discussed in the descriptive section, claims and drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment of the invention can also be applied in other embodiments.

One advantage of the arrangement according to the invention is that not as much space is needed at the bottom of the elevator shaft as in prior-art solutions. Thus more shaft space is available for use in the height direction of the shaft through the whole cross-section of the shaft. One advantage is thus that valuable space is saved in the elevator shaft and especially in the bottom part of the shaft. This kind of need to save space occurs especially in old buildings, in which the invention bestows a distinct advantage. Another advantage is that the solution according to the invention can be used both in constructing new elevators and in modernizing old solutions, in which case the old and still usable parts of the elevator can still be utilized by means of the solution in question. Another advantage is that the arrangement is operationally reliable, simple and inexpensive to implement. One advantage is that the modular construction enables the inclusion of various additional functions in connection with the diverting pulley systems as a part of a modular unit, in which case numerous different functions/structures can quickly be connected to the elevator at one time. One advantage also is that owing to the placement of the diverting pulleys space to fit many elevator components remains between the guide rails, in which case the elevator is compactly formed. One advantage is also faster installation.

The traction sheave elevator without counterweight according to the invention comprises a drive machine with traction sheave, hoisting ropes, an elevator car, which is supported on the hoisting ropes such that the hoisting ropes are on one side of the elevator car, car guide rails for guiding the elevator car, which car guide rails are on one side of the elevator car. The elevator comprises a plurality of rope pulley modules, which comprise a plurality of diverting pulleys. With this construction one or more of the aforementioned advantages can be achieved.

According to one embodiment of the invention the elevator comprises a rope pulley module fixed to the elevator car, a rope pulley module fixed to the top part of the elevator shaft or the like, and a rope pulley module fixed to the bottom part of the elevator shaft or the like. The advantage of this is that essentially the whole hoisting machine can manufactured to be modular.

According to one embodiment of the invention all the rope pulley modules are essentially situated between the guide rails of the elevator car. The advantage of this is that it is possible to perform the positioning of the modules with respect to each other quickly and accurately. One advantage is also the compact construction of the elevator, since the essential parts of the hoisting machine of the elevator are situated between the guide rails and the space in the shaft taken by the machine is less than previously.

According to one embodiment of the invention at least a part, preferably all, of the rope pulley modules each comprise a plurality of co-axial rope pulleys. The advantage of this is that, among other things, the rope pulleys of the rope pulley module take less of the cross-section area of the shaft.

According to one embodiment of the invention the axes of rotation of the diverting pulleys are essentially at a right angle with respect to the plane of the wall on the side of the guide rails of the elevator car. The advantage of this is that, among other things, the rope pulleys of the rope pulley module take less of the cross-section area of the shaft.

According to one embodiment of the invention the elevator comprises a rope pulley module, which comprises a traction sheave with its machine and at least one diverting pulley, in the proximity of the end of the shaft.

According to one embodiment of the invention the machine of the elevator contains a flat-shaped permanent-magnet motor.

Preferably the shaft of the motor is essentially at a right angle to the rear wall of the elevator car. The advantage of this is that the machine does not form an obstacle to passage for the elevator car but instead the elevator car can ascend so high that its top part is beside the motor when the car has been driven to the top part of the shaft.

In the following, the invention will be described in more detail by the aid of one of its embodiments with reference to the attached drawings, wherein

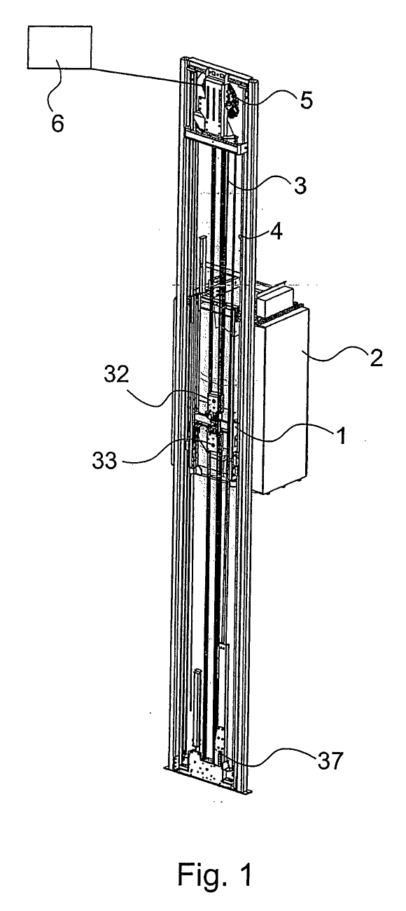

FIG. 1 presents an oblique rear view of a rucksack-type elevator, in which the arrangement according to the invention is used,

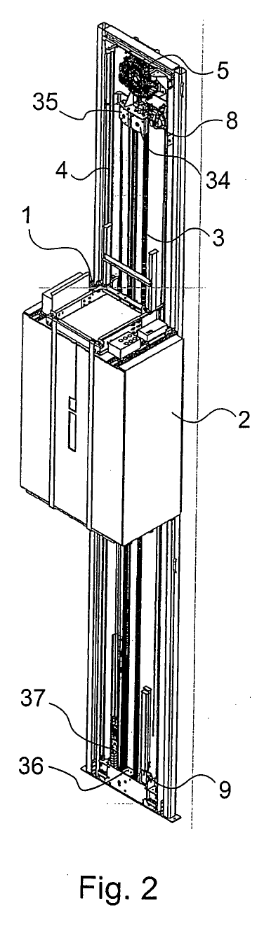

FIG. 2 presents an oblique front view of an elevator according to FIG. 1,

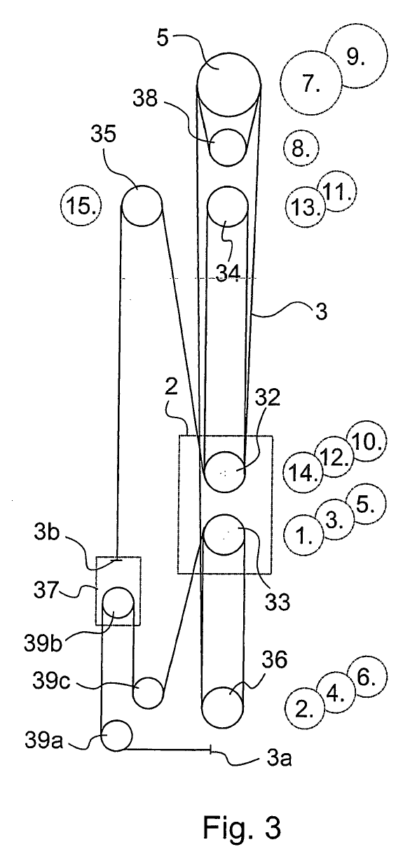

FIG. 3 presents a simplified diagrammatic view of one roping solution of an elevator according to FIGS. 1 and 2,

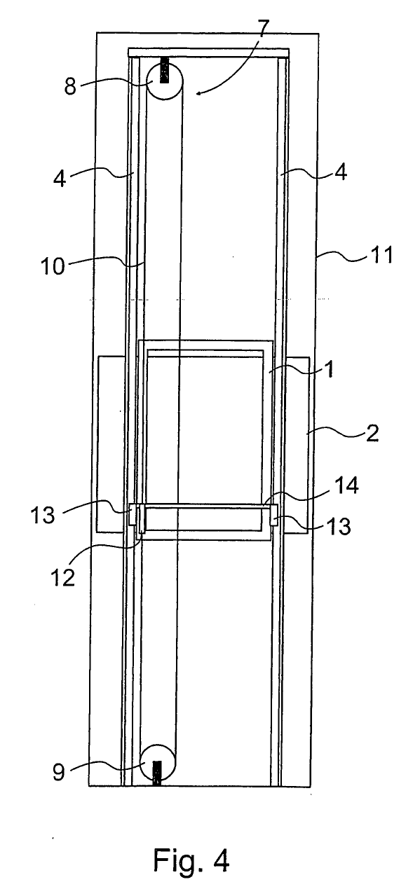

FIG. 4 presents a simplified diagrammatic rear view of an elevator according to FIGS. 1 and 2,

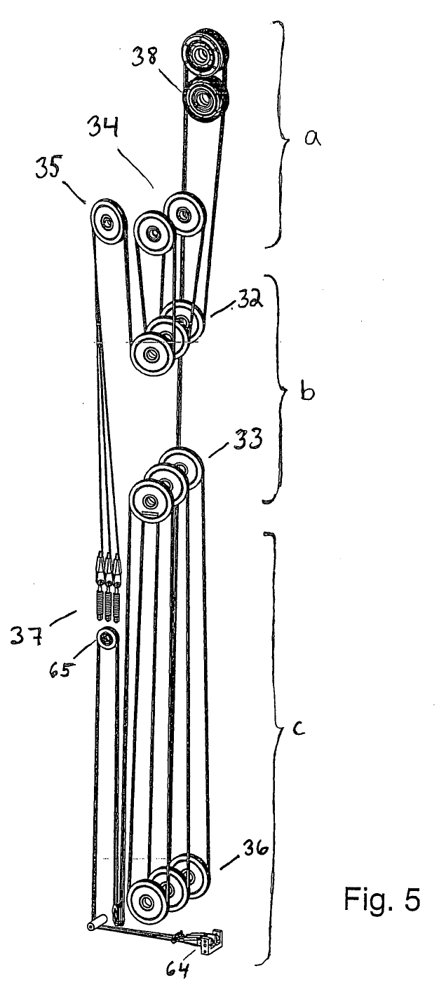

FIG. 5 presents a simplified and diagrammatic view of one alternative roping solution of an elevator,

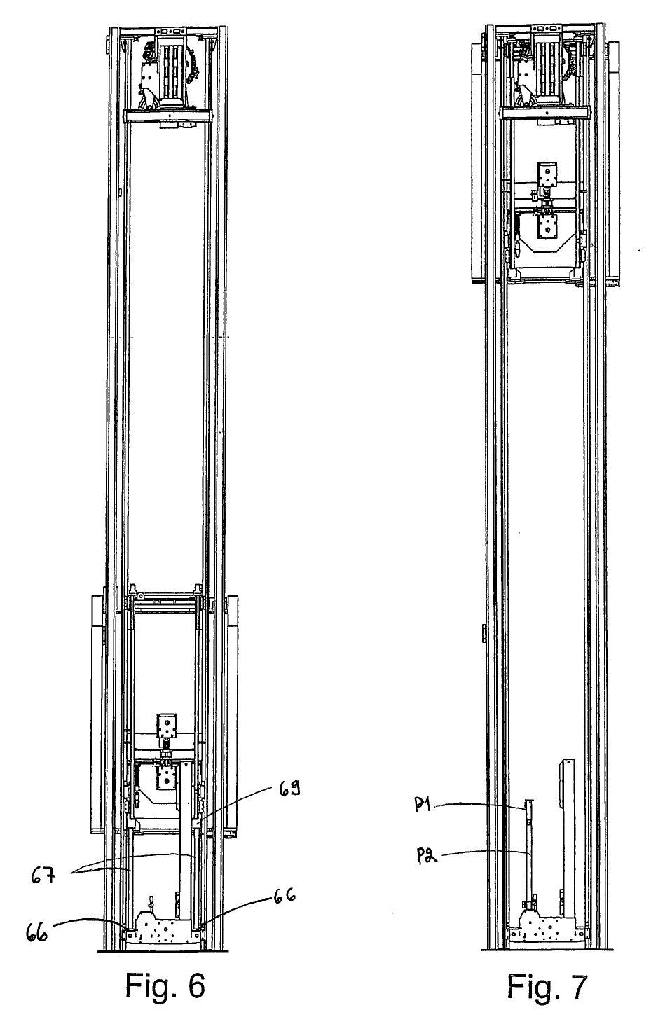

FIG. 6 presents a simplified view of a car sling module when it is near the bottom module,

FIG. 7 presents a simplified view of a car sling module when it is essentially on the same level as the top module,

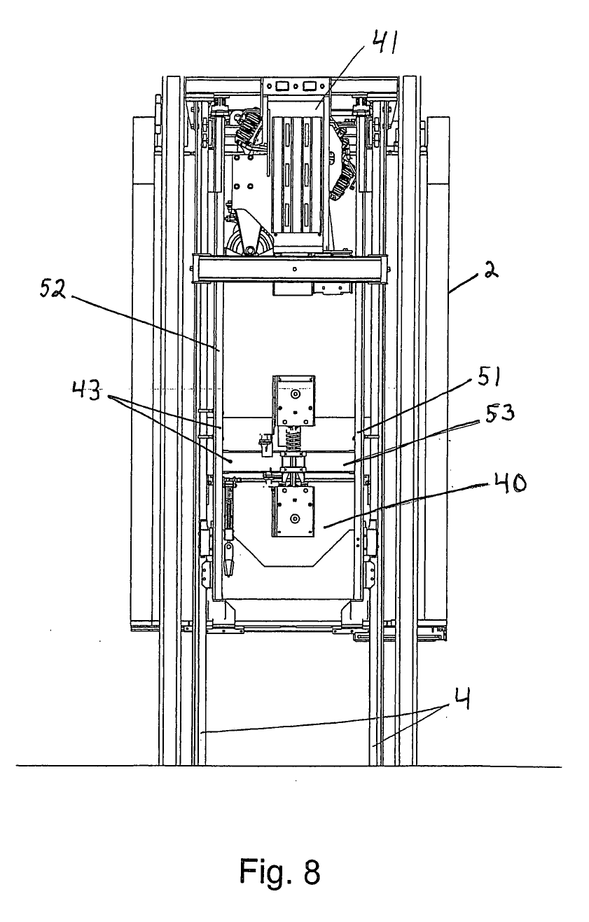

FIG. 8 presents a detail from FIG. 7,

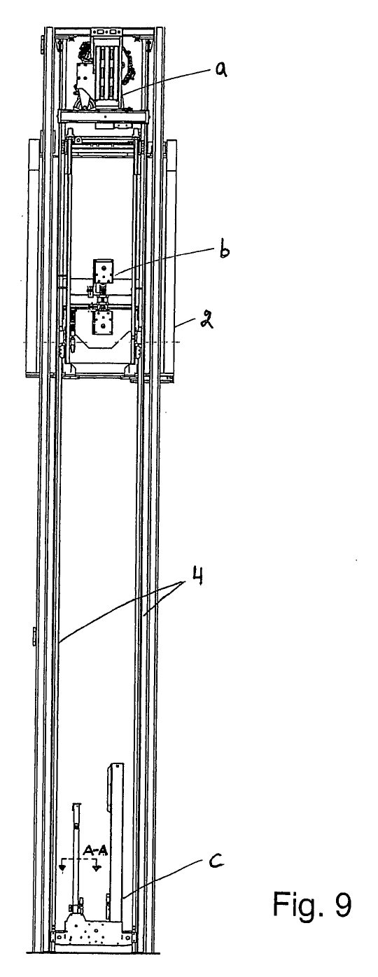

FIG. 9 presents a simplified view of a car sling module when it is near the top module,

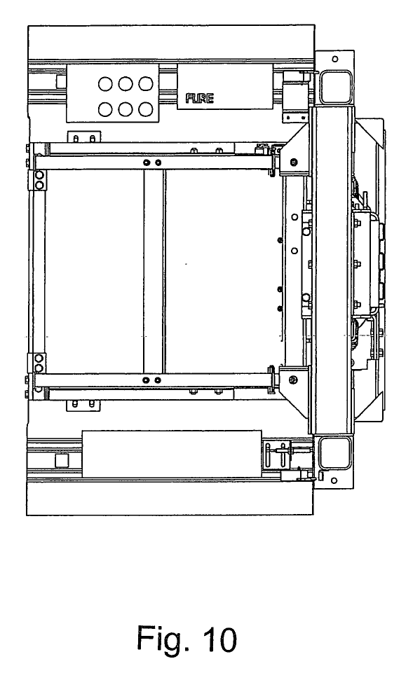

FIG. 10 presents a top view of a rucksack-type elevator, in which the arrangement according to the invention is used,

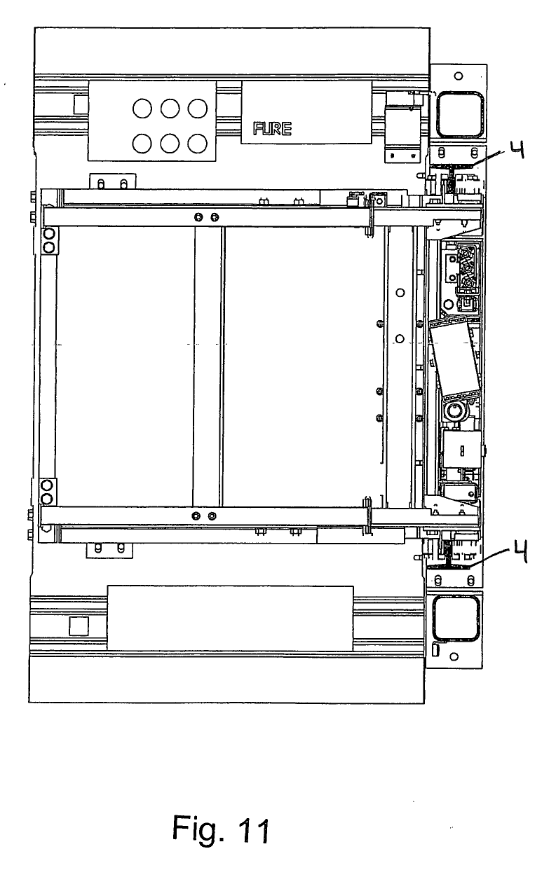

FIG. 11 presents a partially sectioned top view of a rucksack-type elevator, in which the arrangement according to the invention is used,

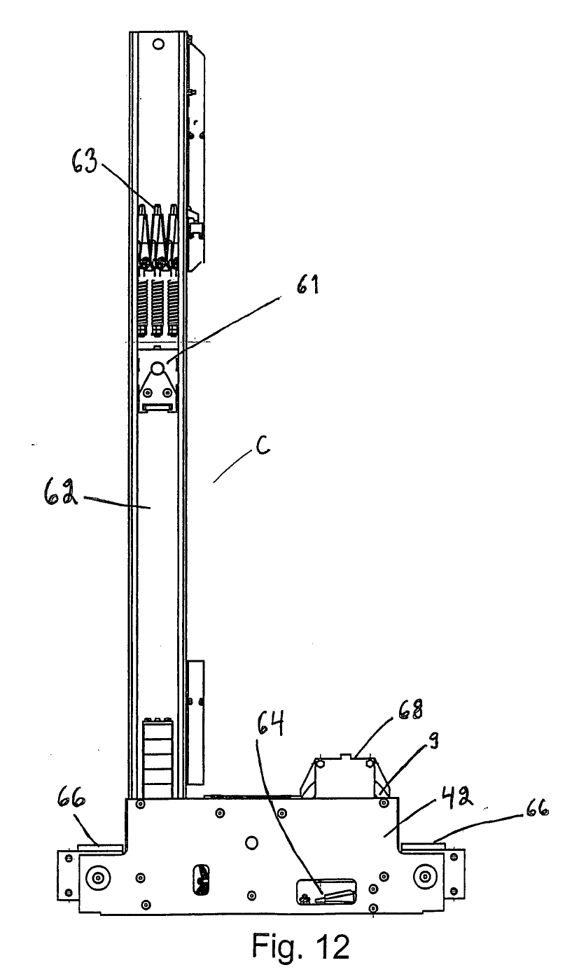

FIG. 12 presents a simplified and diagrammatic view of a bottom module with its bottom safety devices and with its rope fixings,

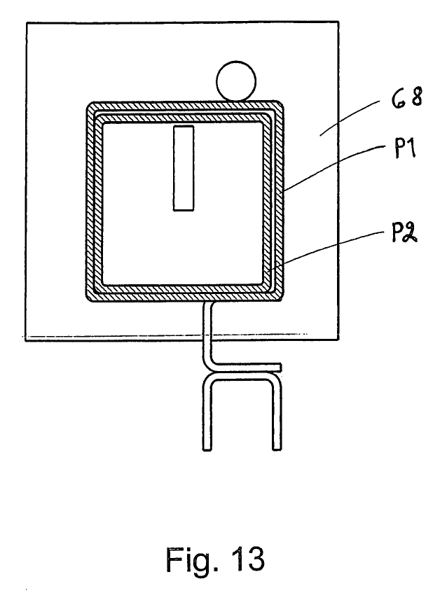

FIG. 13 presents a diagrammatic view of a pillar that can be assembled.

FIGS. 1 and 2 present an oblique rear view and an oblique front view of one traction sheave elevator without counterweight applying the arrangement according to the invention, which comprises at least an elevator hoisting machine 5 with its hoisting motor, an elevator control system 6, as well as an elevator car 2 fitted in a car sling 1 and moving in an essentially vertical direction along guide rails 4, which is suspended on hoisting ropes 3 by means of at least the diverting pulleys of the diverting pulley packages 32 and 33 on the car sling 1 essentially inside the guide rail line of the guide rails 4. The elevator receives its lifting force from the hoisting machine 5 as a result of the friction between the traction sheave it incorporates and the hoisting ropes 3. The elevator suspension also comprises at least the diverting pulley packs 34 and 35 in the top part of the elevator shaft as shown in FIG. 2 as well as the diverting pulley pack 36 in the bottom part of the shaft, which contain diverting pulleys around which the hoisting roping 3 is conducted to pass. Both ends of the hoisting ropes 3 are fixed e.g. to a rope compensation appliance 37 in the lower part of the elevator shaft.

An essential feature of the arrangement according to the invention is space usage that is as small and as suited to the space reserved for the elevator shaft as possible. In this case as many elevator components as possible are fitted inside the rucksack-type car sling 1 and the guide rail line of the guide rails 4, in which case the elevator car 2 with its doors and other components as well as the guide rail line of the elevator take as little shaft space laterally as possible throughout the height of the shaft. For example, all the aforementioned diverting pulleys of the diverting pulley packs 32-36 are situated essentially inside the guide rail line of the guide rails 4 of the elevator car 2. Preferably the components of the elevator are divided into modules, which can be delivered to the installation site separately. In this case e.g. the top module a comprises at least a hoisting machine 5 with its traction sheave, the diverting pulley packs 34 and 35, as well as a part of the overspeed governor, e.g. the upper rope pulley 8 of the overspeed governor. Correspondingly the car module b comprises at least the diverting pulley packs 32 and 33, the fixing mechanism and fastening mechanism of the rope of the overspeed governor, the safety gear structure and other suitable structural parts that move along with the elevator. The bottom module c further comprises at least the diverting pulley pack 36, the rope compensation mechanism 37, the lower diverting pulley 9 of the overspeed governor and other suitable structural parts. The modular division is illustrated further in FIG. 5.

FIG. 3 presents a simplified and diagrammatic view of one elevator roping suspension according to FIGS. 1 and 2. In order to clarify the rope passages, the interpositioning and dimensional relationships of the rope pulleys are not correctly proportioned. Additionally, to aid understanding of the suspension, at the position of all rope pulleys, i.e. at the position of all traction sheaves and diverting pulleys, a circle, which presents the rope pulley, provided with an ordinal number between 1. and 15. circled with a dot-and-dash line is drawn at the same height at the position of the rope pulley in question. The ordinal number describes the sequence of the rope bend occurring on the rope pulley that affects the suspension ratio, starting from the first end 3a of the rope 3. The diverting pulley packs 32, 33 and 36 contain three diverting pulleys next to each other, the diverting pulley pack 34 contains two diverting pulleys next to each other and the diverting pulley pack 35 contains only one diverting pulley.

The hoisting roping 3 is fixed at its first end 3a to a fixed point in the bottom part of the elevator shaft. The hoisting roping is conducted from its fixing point of the first end 3a to pass e.g. via the diverting pulleys 39a-c to the lower diverting pulley pack 33, which contains e.g. three diverting pulleys next to each other and which moves along with the elevator car 2. At least one of the diverting pulleys 39a-c is incorporated as a part of the rope compensating appliance 37 and is equipped to function, for its part, as a compensating element of the hoisting roping 3. In the diverting pulley pack 33 the hoisting ropes 3 are conducted to pass over the top of first diverting pulley of the diverting pulley pack and to descend down to the first diverting pulley of the diverting pulley pack 36 in the bottom part of the elevator shaft, where a second bending is made and after passing around the bottom of the aforementioned diverting pulley the hoisting ropes are conducted upwards again to the second diverting pulley of the diverting pulley pack 33, in which after a third bending implemented over the top of the diverting pulley the hoisting roping is conducted downwards again to the second diverting pulley of the diverting pulley pack 36 and after a fourth bending effected around the bottom of this upwards again to the third diverting pulley of the diverting pulley pack 33, around the top of which a fifth bending is made and the hoisting roping is conducted downwards again to the third diverting pulley of the diverting pulley pack 36, around the bottom of which a sixth bending is made. After this the hoisting roping is conducted to the diverting pulley moved by the hoisting machine 5 at the top end of the elevator shaft, i.e. the traction sheave, over the top of which a seventh bending is made and the hoisting roping is conducted to the diverting pulley 38 below the traction sheave, around the bottom of which the hoisting roping is bent for the eighth time to pass again to the traction sheave of the hoisting machine 5, over the top of which after the ninth bending the hoisting roping 3 is conducted to the upper diverting pulley pack 32, in which are e.g. three diverting pulleys next to each other and which moves along with the elevator car 2. The tenth bending is made around the bottom of the first diverting pulley of the diverting pulley pack 32, after which the hoisting roping is conducted upwards to the first diverting pulley of the diverting pulley pack 34 in the top part of the shaft. After the eleventh bending over the top of this diverting pulley the hoisting roping 3 is lead again downwards under the second diverting pulley of the diverting pulley pack 32, in which after having completed the twelfth turning the hoisting roping is conducted again upwards to the second diverting pulley of the diverting pulley pack 34 and further after the thirteenth bending over the top of it downwards again and under the third diverting pulley of the diverting pulley pack 32, in which after having completed the fourteenth turning the hoisting roping is conducted again upwards to the diverting pulley of the diverting pulley pack 35 in the top part of the shaft, over the top of which the last, i.e. the fifteenth, bending is made and the hoisting roping is conducted downwards to its fixing point of its second end 3b in the rope compensation appliance 37.

FIG. 4 presents a simplified and diagrammatic rear view of a rucksack-type elevator according to FIGS. 1 and 2. For the sake of clarity, some parts of the elevator have been omitted from the figure, such as the hoisting machine and the hoisting roping as well as components of these. The elevator car 2 fitted in the car sling 1 is fitted to move along the guide rails 4 in the elevator shaft 11 in an essentially vertical direction. The overspeed governor pulley 8 of the overspeed governor 7 is fixed to the top part of the elevator shaft 11 and the diverting pulley 9 incorporated in the overspeed governor 7 is fixed to the bottom part. The rope 10 of the overspeed governor is fitted as a loop around these pulleys such that the first end of the rope 10 is fitted to the top part of the tightening element 12 incorporated in the arrangement according to the invention, from where it is conducted upwards to pass over the top of the overspeed governor pulley 8, after which under the diverting pulley 9 in the bottom part of the elevator shaft 11, from where onwards to the bottom part of the tightening element 12, to which the second end of the rope 10 is fixed. The tightening element 12 is fixed to the synchronization rod 14 of the safety gears 13 fixed to the bottom part of the car sling 1 near the first guide rail 4. The tightening element 12 is essentially inside the guide rail line of the guide rails 4, in which case the tightening element 12 does not take lateral space of the shaft. The safety gears 13 are fixed to the outer edges of the car sling 1 around the guide rails 4. The overspeed governor 7 is arranged to operate such that when the elevator car 2 moves downwards at too great a speed, the overspeed governor pulley 8 stops, e.g. from the effect of centrifugal force and at the same time stops the movement of the overspeed governor rope 10, in which case when the elevator car 2 still moves downwards the stopped rope 10 pulls the wedges incorporated in the safety gears 13 via the synchronization rod 14 against the guide rails 4 and thus the movement of the elevator car 2 also stops.

FIG. 5 shows an alternative roping solution with traction sheave and diverting pulleys as well as with the fixings of the roping. Some parts (including the elevator car, guide rails, module frames, etc.) have been omitted from the figure, in order to display the rope pulley modules well. The components of which the rope pulley modules a, b and c are comprised can be seen in the figure. The interpositioning of the internal diverting pulleys of the diverting pulley pluralities 32, 33, 34 and 36 is such that the axes of rotation of the diverting pulleys are essentially parallel and coaxial. Preferably all the diverting pulleys of each pack rotate around a common axis. The directions of the axes of rotation of the diverting pulley pluralities 32, 33, 34 and 36 as well as of the traction sheave and of the diverting pulley 38 are essentially of the same direction, such that they point towards the elevator car. In this case the total space taken by a diverting pulley plurality fitted to be an individual pack is formed to be small. Thus there is not necessarily any need either to arrange an individual axis of rotation for each diverting pulley. Thus the module formed is formed lighter in terms of its weight than previous solutions, which is extremely important in elevator solutions without counterweight. Neither does the placement of the diverting pulleys in the manner described necessarily require a wide guide rail span, as a result of which the solution is also suited to narrow elevator cars. Thus space remains inside the guide rail line also to fit as many components of the elevator as possible, in which case the elevator is formed to be compact. Each rope pulley module a, b and c is formed to comprise its own module frame 41, 42 and 43, to which the parts of which each module is comprised are fixed. Some sub-modules can also be fixed to the module frame. For example, the diverting pulleys or diverting pulley pluralities 33 and 34 can be fixed to the module frame 43 of the car module b such that they are assembled into their own sub-modules in advance before the assembly of the final module. The module frames 41, 42 and 43 can each be composed of one or more parts fixed to each other, which form the module of a fixing base for the actual parts of the elevator hoisting machine such as e.g. for the diverting pulleys. Thus the parts of the hoisting machine are fixed to the module frames in advance, the advantage of which is that in the installation of the elevator the hoisting machine comprises only a small quantity of units to be installed, each of which pre-manufactured unit, i.e. module, comprises parts that are pre-positioned with respect to each other. One advantage is, among others, faster installation. There are preferably three modules (the top module a, the bottom module c and the car module b), each of which is installed one on top of the other between the guide rails 4. Thus the positioning of the modules with respect to each other is quick and accurate because the guide rails 4 form a reliable reference that is already in position, on the basis of which the modules are easy to position. The module frame 42 of the car module b can be formed to comprise a sling 1.

FIG. 6 shows a car sling moving upwards from the bottom module, i.e. in this case upwards from the bottom safety appliance, because the pillars of the bottom safety appliance are still pressed together. The figure describes a situation in which the pillars 67 are in the operating position and placed on top of the fixing places 66 and meet the buffers 69 of the car. In FIG. 7 the car sling module has reached its top position, i.e. is essentially at the same level as the top module or has even driven above it and the pillars of the bottom safety appliance are at full length acting if necessary as buffers. The figure describes a situation in which the pillars are in the storage position and the pillars p1 and p2 of which they are comprised are nested together.

FIG. 8 shows a detail of FIG. 7, which demonstrates well that the car sling is higher than the top module, i.e. when the top module is thin enough the car sling can rise ascend than it and fully utilize the shaft or similar. Thus, any fixed structure whatsoever can function as the shaft, which can comprise just the guide rails, one wall, to which the brackets forming the track of the car are fixed, or a movable shaft, which can be manufactured from any material whatsoever. The module frame 43 of the car module comprises two vertical beams 51, 52, which are at a distance from each other in the space between the car guide rails, and a horizontal beam 53, to which the third and fourth diverting pulley or diverting pulley plurality 32, 33 are arranged in the vertical direction one directly above the other such that the third diverting pulley or diverting pulley plurality 32 is above the horizontal beam 53 and the fourth diverting pulley or diverting pulley plurality 33 is below the horizontal beam 53. The car comprises an openable and closable service hatch 40, which is on the bottom part of the wall of the car on the side of the car guide rails 4 and the rope hoisting machine. The devices and appliances in the car module b requiring servicing and/or adjustment, such as the third and fourth diverting pulley or diverting pulley plurality 32, 33, the load weighing device, the parts of the safety gear, the positioning sensors, etc., are disposed essentially in the proximity of the service hatch 40 at the point of the lower part of the car 2 for making them easy to access from inside the car 2.

In the solution of the embodiment of FIG. 9 the car sling cannot go past the top module, because the top module is so thick or otherwise of such a construction that the car is not able to pass it.

In FIG. 10 the solution according to the invention is viewed from above, showing the car sling and a part of the top module. In FIG. 11 the preceding figure is sectioned, revealing the parts of the top module.

FIG. 12 shows, among other things, the rope fixings and the pillar fixing places 66 in the bottom safety equipment, which pillars 67 are presented as a top view in FIG. 13. FIG. 12 presents a second rope pulley module c separated from the other structures of the elevator. FIG. 13 shows the nested pillars p1 and p2 of which the pillars 67 of the safety device are comprised illustrated as a section of FIG. 9 from the A-A direction when the pillars are in the storage position. A vertical guide rail pillar 62 is arranged as a part of the second module frame 42. The guide rail pillar contains a sliding carriage 61, which is guided to move under the guidance of the guide rail pillar 62 and which sliding carriage 61 comprises a second tightening appliance 63 for fixing the second end of the rope or of the ropes and a diverting pulley 65, via which the rope is conducted to the first fixing appliance 64. The guide rail pillar 62 is arranged to be disposed in the space between the car guide rails 4 and to the side of the vertical path of passage of the third and fourth diverting pulley or plurality of diverting pulleys 32, 33 that are connected to the car module that moves along with the car 2. The second rope pulley module c comprises a bottom safety device, which can be set between the operating position and the storage position, in both of which positions the bottom safety device is between the car guide rails and on the other hand between the path of passage of the car 2 and the wall of the shaft 11, and in which operating position the bottom safety device enables adequate bottom safety space between the elevator car and the bottom of the shaft and prevents the car from descending into the bottom safety space, and in which storage position the bottom safety device is out of the operating position and allows the car to descend to the proximity of the bottom of the shaft. The bottom safety device comprises two pillars 67, which in the operating position can be fixed in a vertical attitude on top of the buffer stoppers 66 on the second module frame 42, and each pillar 67 comprises a first pillar p1 and a second pillar p2, of which the first pillar p1 comprises a hollow interior space, inside which the second pillar p2 is fitted to be placed in the storage position. The second module frame 42 comprises a fixing base 68, which is fitted above the diverting pulley 9 of the overspeed governor 7 and to which fixing base 68 a first pillar p1, the interior space of which contains a second pillar p2, can be fixed vertically into the storage position. The thickness of the first pillar p1 is with clearance smaller than the diameter of the diverting pulley 9 of the overspeed governor 7 such that in the storage position the pillars p1, p2 fit inside the loop formed by the rope 10 of the overspeed governor 7 and in the storage position the pillars p1, p1 are at the side of the vertical path of passage of the third and fourth diverting pulley or diverting pulley plurality 32, 33 connected to the car module b that moves along with the car. The construction of FIG. 13 can be utilized in all the embodiments of the invention.

It is obvious to the person skilled in the art that the invention is not limited solely to the example described above, but that it may be varied within the scope of the claims presented below. Thus, for example, the arrangement according to the invention can be used just as well in other kinds of elevators than in the rucksack-type elevator described above.

It is also obvious to the person skilled in the art that the appliance according to the invention can be used also just as well in an elevator with counterweight instead of an elevator without counterweight.

It is further obvious to the person skilled in the art that the roping suspension of the elevator car can vary. In this case, depending on the suspension ratio, there can also be more or fewer diverting pulleys than what is described above, in which case the diverting pulleys can be disposed so that e.g. only one, two that are one on top of the other, or more than three that are one on top of the other are positioned inside the guide rail line. Furthermore, the rope compensating appliance and the ends of the hoisting ropes can also, depending on the suspension ratio, be fixed to the elevator car instead of to a fixed place in the shaft.

It is obvious to the person skilled in the art that the invention is not limited to the embodiments described above, in which the invention is described using examples, but that many adaptations and different embodiments of the invention are possible within the scope of the inventive concept defined by the claims presented below.

1. Traction sheave elevator without counterweight, which comprises
drive machinery with traction sheave,
hoisting ropes,
an elevator car, which is supported on hoisting ropes such that the hoisting ropes are on one side of the elevator car,
car guide rails for guiding the elevator car, which car guide rails are on one side of the elevator car,
wherein the elevator comprises a plurality of rope pulley modules, each of which comprises a plurality of diverting pulleys.

2. Elevator according to claim 1, wherein the elevator comprises a rope pulley module fixed to the elevator car, a rope pulley module fixed to the top part of the elevator shaft or the like, and a rope pulley module fixed to the bottom part of the elevator shaft or the like.

3. Elevator according to claim 1, wherein at least a part, preferably all, of the rope pulley modules comprise a plurality of diverting pulleys, the axes of rotation of which are parallel.

4. Elevator according to claim 1, wherein at least a part, preferably all, of the rope pulley modules comprise a plurality of coaxial rope pulleys.

5. Elevator according to claim 3, wherein the axes of rotation of the diverting pulleys are essentially at a right angle with respect to the plane of the wall on the side of the guide rails of the elevator car.

6. Elevator according to claim 1, wherein the elevator comprises a type of rope pulley module, which comprises a traction sheave with its machine and at least one diverting pulley or diverting pulley plurality, in the proximity of the end of the shaft.

7. Elevator according to claim 1, wherein all the rope pulley modules are situated between the guide rails.

8. Elevator according to claim 1, wherein the rope pulley module situated in the proximity of the top end of the shaft or the like forms a top module, the rope pulley module situated in the proximity of the bottom end shaft or the like forms a bottom module, and the rope pulley module moving in the elevator shaft in connection with the elevator car, or the like, guided on its track forms the car module, and in that the hoisting ropes connect the top module, the car sling module and the bottom module forming a suspension ratio of X: 1, where X is 2, 4, 6, 8, 10, etc.

9. Elevator according to claim 1, wherein the machine contains a flat-shaped permanent-magnet motor.

10. Elevator according to claim 1, wherein the rope hoisting machine comprises
a first rope pulley module, which contains a motor installed on the first module frame, a traction sheave and a first diverting pulley or diverting pulley plurality, and which first rope pulley module is fitted between the car guide rails in the first end of the shaft and fixed to the car guide rails and/or to the wall of the shaft,
a second rope pulley module, which contains a second diverting pulley or diverting pulley plurality installed on the second module frame, and which second rope pulley module is fitted between the car guide rails in the second end of the shaft and which second module frame is fixed to the car guide rails and/or to the wall of the shaft, and
a car module, which contains a third and a fourth diverting pulley or diverting pulley plurality installed on the third module frame, which are fitted between the car guide rails beside the car and which third module frame is connected to the car sling, i.e. to the sling, of the car.

11. Elevator according to claim 1, wherein the motor of the hoisting machine is on the side of the path of passage of the car and/or the sling out of the way of preventing the passage of the top part of the car past the motor, and in that in the top end of the shaft, when the car has been driven to its topmost position such that the top part of the car is beside the motor, the third diverting pulley that moves along with the car is at a distance below the first diverting pulley.

12. Elevator according to claim 1, wherein the elevator comprises an overspeed governor, which comprises a rope fixed at both its ends to the car or to the sling and diverting pulleys fixed on bearings to the first module frame and correspondingly to the second module frame, via which the rope of the overspeed governor is conducted, and which overspeed governor rope and diverting pulleys are fitted between the car guide rails.

13. Elevator according to claim 1, wherein buffers are arranged on the module frame of the first rope pulley module for limiting the movement of the car, in that the buffers are fitted to extend from between the car guide rails to the path of passage of the car, and in that the car or the sling comprises stoppers, which are fitted to opposingly face the buffers in the vertical direction.

14. Elevator according to claim 1, wherein a vertical guide rail pillar and a sliding carriage, which is guided to move under the guidance of the guide rail pillar, are arranged on the module frame of the second rope pulley module, and which sliding carriage comprises a second fixing appliance for fixing the second end of the rope or of the ropes, and a diverting pulley, via which the rope is conducted to the aforementioned first fixing appliance; and in that the guide rail pillar is situated in the space between the car guide rails and to the side of the vertical path of passage of the third and fourth diverting pulley or diverting pulley plurality connected to the car module that moves along with the car.

15. Elevator according to claim 1, wherein the module frame of the third car module comprises two vertical beams, which are at a distance from each other in the space between the car guide rails, and a horizontal beam, to which the third and fourth diverting pulley or diverting pulley plurality are arranged one on top of the other to face each other in the vertical direction such that the third diverting pulley or diverting pulley plurality is above the horizontal beam and the fourth diverting pulley or diverting pulley plurality is below the horizontal beam.

16. Elevator according to claim 1, wherein the second rope pulley module in the bottom end of the shaft comprises a bottom safety device, which can be set between the operating position and the storage position, in both of which positions the bottom safety device is between the car guide rails and on the other hand between the path of passage of the car and the wall of the shaft, and in which operating position the bottom safety device enables adequate bottom safety space between the elevator car and the bottom of the shaft and prevents the car from descending into the bottom safety space, and in which storage position the bottom safety device is out of the operating position and allows the car to descend to the proximity of the bottom of the shaft.

17. Elevator according to claim 1, wherein the bottom safety device comprises two pillars, which in the operating position can be fixed in a vertical attitude on top of the buffer stoppers on the second module frame, and the pillars comprise a first pillar and a second pillar, of which the first pillar comprises a hollow interior space, inside which the second pillar is fitted to be placed in the storage position; in that the second module frame comprises a fixing base, which is fitted above the diverting pulley of the overspeed governor and to which fixing base a first pillar, the interior space of which contains a second pillar, can be fixed vertically into the storage position; and in that the thickness of the first pillar is with clearance smaller than the diameter of the diverting pulley of the overspeed governor such that in the storage position the pillars fit inside the loop formed by the rope of the overspeed governor and in the storage position the pillars are at the side of the vertical path of passage of the third and fourth diverting pulley or diverting pulley plurality connected to the car module that moves along with the car.

18. Elevator according to claim 1, wherein the car comprises an openable and closable service hatch, which is on the bottom part of the wall of the car on the side of the car guide rails and the rope hoisting machine; and in that the devices and appliances in the car module requiring servicing and/or adjustment, such as the third and fourth diverting pulley or diverting pulley plurality, the load weighing device, the parts of the safety gear, the positioning sensors, etc., are disposed essentially in the proximity of the service hatch at the point of the lower part of the car for making them easy to access from inside the car.

19. Elevator according to claim 1, wherein the elevator is a so-called walk-through elevator hoisted from the side, in which the car comprises two car doors, a first car door and a second car door, which are on opposingly facing walls of the car to enable the car to be walked through; and in that the car guide rails and the rope hoisting machine are on the side of an adjoining side wall with respect to the first and the second car door.

20. Elevator according to claim 1, wherein the elevator comprises a third car door, which is opposingly facing the side wall adjoining the first and the second car door.

21. Elevator according to claim 1, wherein the elevator is a so-called rucksack-type elevator hoisted from the rear, in which the car comprises one car door, which is on the opposite side in relation to the side of the car behind which are the car guide rails and the rope hoisting machine.
